(19) United States
(12) Patent Application Publication
(10) Pub. No.: US 2014/0292676 A1
(43) Pub. Date: Oct. 2, 2014

(54) ELECTRONIC DEVICE AND METHOD FOR CONTROLLING THE ELECTRONIC DEVICE

(71) Applicant: Japan Display Inc., Minato-ku (JP)

(72) Inventors: Makoto HAYASHI, Tokyo (JP); Jouji Yamada, Tokyo (JP); Hirofumi Nakagawa, Tokyo (JP); Michio Yamamoto, Tokyo (JP); Kohei Azumi, Tokyo (JP); Hiroshi Mizuhashi, Tokyo (JP); Kozo Ikeno, Tokyo (JP); Yoshitoshi Kida, Tokyo (JP)

(73) Assignee: Japan Display Inc., Minato-ku (JP)

(21) Appl. No.: 14/180,595

(22) Filed: Feb. 14, 2014

(30) Foreign Application Priority Data
Mar. 29, 2013 (JP) 2013-073868

(51) Int. Cl. G06F 3/041

(52) U.S. Cl. CPC G06F 3/041
USPC 345/173

(57) ABSTRACT

There is provided a sensor-integrated display device including a display surface from which display information is output and a sensor surface to which operation information is input, the display surface and the sensor surface being formed integrally with the sensor-integrated display device as one piece, a data transfer unit which generates and outputs three-dimensional information (RAW-D) in response to a signal sensed on the sensor surface, and an application executing device having a processing function of generating three-dimensional image data in a plurality of points sensed on the sensor surface, based on the three-dimensional information output from the data transfer unit and computing a touch coordinate, based on the generated image data.

### CROSS-REFERENCE TO RELATED APPLICATIONS

This application is based upon and claims the benefit of priority from Japanese Patent Application No. 2013-073868, filed Mar. 29, 2013, the entire contents of which are incorporated herein by reference.

### FIELD

Embodiments described herein relate generally to an electronic device and a method for controlling the electronic device.

### BACKGROUND

Mobile phones, tablets, personal digital assistants (PDA), small-sized mobile personal computers and the like are popularized. These electronic devices have a display panel and an operation panel that is formed integrally with the display panel as one piece.

The operation panel senses a position on its surface in which a user touches as a change in capacitance, for example, and generates a sensing signal. The sensing signal is supplied to a touch signal processing integrated circuit (IC) dedicated to the operation panel and integrated as the IC. The touch signal processing IC processes the sensing signal by a computational algorithm prepared in advance to convert the user's touched position into coordinate data and output the data.

As manufacturing technology advances, the display panel increases in resolution and size. Accordingly, the operation panel is required to sense a position with high accuracy. The operation panel is also required to process data input thereto at high speed depending on applications. Furthermore, a device capable of easily changing an application is desired.

### BRIEF DESCRIPTION OF THE DRAWINGS

FIG. 1 is a block diagram of an electronic device according to an embodiment;

FIG. 2A is a sectional view illustrating a sensor-integrated display device including a display surface or a display panel and an operation surface or an operation panel;

FIG. 2B is an illustration of the principle for generating a touch sensing signal from a signal output from the operation panel;

FIG. 3 is a perspective view illustrating sensor components of the operation panel and a method for driving the sensor components;

FIG. 4 is a block diagram showing one example of a data transfer device and some of the functions that are fulfilled by the applications in the application operation device shown in FIG. 1;

FIG. 5A is a chart showing an example of output timing between a display signal and a drive signal of a sensor driving electrode, which are output from the driver shown in FIGS. 1 and 4;

FIG. 5B is a schematic view illustrating the output of the drive signal of the sensor driving electrode and a driving state of a common electrode;

FIG. 6 is a graph of raw data (sensed data) output from the sensor when no input operation is performed;

FIG. 7 is a graph of raw data (sensed data) output from the sensor when an input operation is performed;

FIG. 8 is an illustration of an example of use of a mobile terminal according to the present embodiment;

FIG. 9 is a flowchart illustrating an example of use of the mobile terminal according to the present embodiment;

FIG. 10 is a flowchart illustrating a specific example (part 1) of use of the mobile terminal according to the present embodiment;

FIG. 11 is a flowchart illustrating a specific example (part 1) of use of the mobile terminal according to the present embodiment;

FIG. 12 is a flowchart illustrating a specific example (part 2) of use of the mobile terminal according to the present embodiment;

FIG. 13 is a flowchart illustrating a specific example (part 2) of use of the mobile terminal according to the present embodiment;

FIG. 14 is an illustration showing a specific example (part 3) of operations of the mobile terminal according to the present embodiment;

FIG. 15 is an illustration showing a specific example (part 4) of operations of the mobile terminal according to the present embodiment;

FIG. 16 is an illustration showing a specific example (part 5) of operations of the mobile terminal according to the present embodiment;

FIG. 17 is a diagram illustrating an example of an operation to perform a coordinate computation of the mobile terminal according to the present embodiment;

FIG. 18A is a diagram showing an equivalent circuit of a sensor to perform a coordinate computation of the mobile terminal according to the present embodiment;

FIG. 18B is a chart showing signal waveforms of the sensor to perform a coordinate computation of the mobile terminal according to the present embodiment;

FIG. 19A is a diagram showing touch images of the sensor to perform a coordinate computation of the mobile terminal according to the present embodiment;

FIG. 19B is a graph showing touch image data of the sensor to perform a coordinate computation of the mobile terminal according to the present embodiment; and

FIG. 20 is a flowchart showing a coordinate computation procedure of the mobile terminal according to the present embodiment.

### DETAILED DESCRIPTION

Embodiments will be described hereinafter with reference to the accompanying drawings.

According to one embodiment, there are provided an electronic device which is flexibly adaptable to a variety of applications and which is able to provide a number of information items for the applications and a method for controlling the electronic device.

An electronic device according to one embodiment comprises a sensor-integrated display device including a display surface from which display information is output and a sensor surface to which operation information is input, the display surface and the sensor surface being formed integrally with the sensor-integrated display device as one piece, a data transfer unit which generates and outputs three-dimensional information in response to a signal sensed on the sensor surface, an image generation unit which generates three-dimensional image data in a plurality of points sensed on the sensor surface, based on the three-dimensional information output from the data transfer unit, and a coordinate computation unit which computes a coordinate value of a conductor operated on the sensor surface, based on the image data generated by the image generation unit.

According to the embodiment, different coordinate computation algorithms can be achieved by three-dimensional analysis of touch data.

Furthermore, a variety of computations can be achieved by analyzing and computing the touch data using a high-speed application processor that can be combined with a plurality of coordinate computation algorithms.

An embodiment will further be described with reference to the drawings.

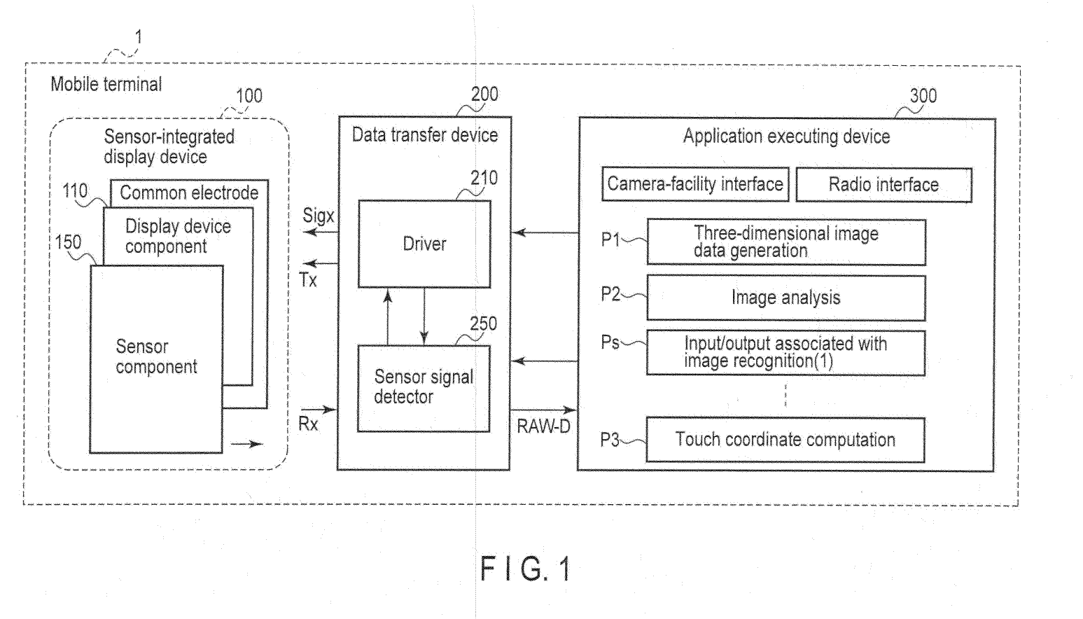

FIG. 1 shows a mobile terminal 1 according to the embodiment. The mobile terminal 1 is an electronic device including a sensor-integrated display device 100, a data transfer device 200 and an application executing device 300. The sensor-integrated display device 100 is formed integrally with a display surface (display panel) that outputs display information and a sensor surface (operation panel) that receives operation information as one piece. The data transfer device 200 generates three-dimensional information (RAW-D) in response to a signal sensed by the sensor surface and outputs the three-dimensional information. The application executing device 300 has a processing function of generating three-dimensional image data on a plurality of points sensed by the sensor surface on the basis of the three-dimensional information (RAW-D) output from the data transfer device 200 and analyzing a conductor's operation performed on the sensor surface on the basis of the three-dimensional image data.

Since the sensor-integrated display device 100 is formed integrally with the display surface and the sensor surface as one piece, it includes a display device component 110 and a sensor component 150.

The sensor-integrated display device 100 is supplied with a display signal (a pixel signal) from a driver 210, which will be described later. When the device 100 receives a gate signal from the driver 210, a pixel signal is input to a pixel of the display device component 110. A voltage between a pixel electrode and a common electrode depends upon the pixel signal. This voltage displaces direction of liquid crystal molecules between the electrodes to achieve brightness corresponding to the direction of displacement of the liquid crystal molecules.

The sensor-integrated display device 100 can be designated as an input sensor-integrated display unit, a user interface or the like.

A display unit that is, for example, formed of a liquid crystal display panel or a light-emitting element such as an LED or organic EL, can be employed as the display device component 110. The display device component 110 can be simply designated as a display. The sensor component 150 can be of a capacitive sensing type, an optical sensing type or the like. The sensor component 150 can be designated as a panel for sensing a touch input.

The sensor-integrated display device 100 is coupled to the application executing device 300 via the data transfer device 200.

The data transfer device 200 includes the driver 210 and a sensor signal detector 250. Basically, the driver 210 supplies the display device component 110 with graphics data that is transferred from the application executing device 300. The sensor signal detector 250 detects a sensor signal output from the sensor component 150.

The driver 210 and sensor signal detector 250 are synchronized with each other, and this synchronization is performed under control of the application executing device 300.

The application executing device 300 is, for example, a semiconductor integrated circuit (LSI) formed as, for example, an application processor, which is incorporated into an electronic device such as a mobile phone. The device 300 serves to complexly perform a plurality of functions, such as Web browsing and multimedia processing, using software such as an OS. The application processor can perform a high-speed operation and can be configured as a dual core or a quad core. Favorably, the operation speed of the application processor is, for example, 500 MHz and, more favorably, it is 1 GHz.

The driver 210 supplies a display signal (a signal into which the graphics data is analog-converted) to the display device component 110 on the basis of an application. In response to a timing signal from the sensor signal detector 250, the driver 210 outputs a sensor drive signal Tx for gaining access to the sensor component 150. In synchronization with the sensor drive signal Tx, the sensor component 150 outputs a sensor signal Rx and supplies it to the sensor signal detector 250.

The sensor signal detector 250 slices the sensor signal Rx, eliminates noise therefrom and supplies the noise-eliminated signal to the application executing device 300 as raw reading image data (three-dimensional image data). In this embodiment, the raw reading image data can be designated as raw data (RAW-D) or sign-eliminated raw data.

When the sensor component 150 is of a capacitive sensing type, the image data is not only two-dimensional data simply representing a coordinate but may have a plurality of bits (e.g., three to seven bits) which vary with the capacitance. Thus, the image data can be designated as three-dimensional data including a physical quantity and a coordinate. The capacitance varies with the distance (proximity) between a targeted conductor (e.g., a user's finger) and a touch panel and thus the variation can be considered to be a change in physical quantity.

Below is the reason that the sensor signal detector 250 of the data transfer device 200 directly supplies image data to the application executing device 300, as described above.

The application executing device 300 is able to perform its high-speed operating function to use the image data for various purposes.

New different applications are stored in the application executing device 300 according to user's different desires. As for the new applications, there is a case where an application requires to change or select an image data processing method, reading timing, a reading format, a reading area or a reading density in accordance with data processing.

If, in the above case, only the coordinate data is acquired as in the prior art device, the amount of acquired information is restricted. In the device of the present embodiment, however, if the raw three-dimensional image data is analyzed, for example, distance information corresponding to the proximity of the conductor as well as coordinate information can be acquired.

In order to expand the functions performed by the applications, it is desired that the data transfer device 200 should follow different operations under the control of the applications. Thus, as the simplest possible function, the data transfer device 200 is configured to select sensor signal reading timing, a reading area, a reading density or the like arbitrarily under the control of the applications. This will be described later.

In the present embodiment, the application executing device 300 is configured, for example, as a single semiconductor integrated circuit that is designated as what is called an application processor. The semiconductor integrated circuit incorporates a base band engine having a radio interface (see FIG. 1) to allow different applications to be performed. The application executing device 300 may include, for example, a camera-facility interface as well as the radio interface. The application executing device 300 also includes an image data generation unit (P1), an image analysis unit (P2), an application execution unit (Ps) and a touch coordinate computation unit (P3). The image data generation unit (P1) generates three-dimensional image data on a plurality of points sensed on the sensor surface of the sensor component 150 on the basis of the raw data (RAW-D) received from the sensor signal detector 250. The image analysis unit (P2) recognizes a conductor's operation performed on the sensor surface on the basis of the image data generated by the image data generation unit. The application execution unit (Ps) executes an application corresponding to the operation recognized by the image analysis unit (P2).

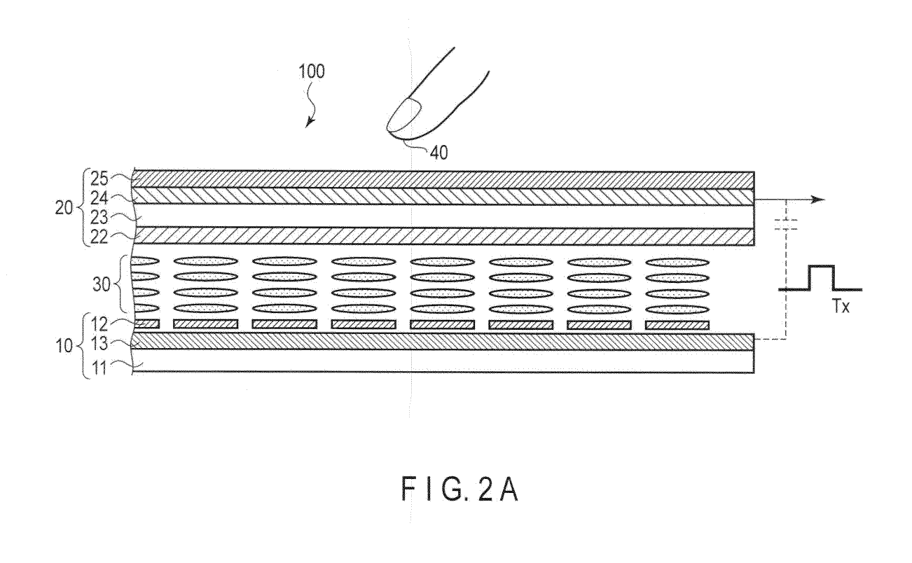

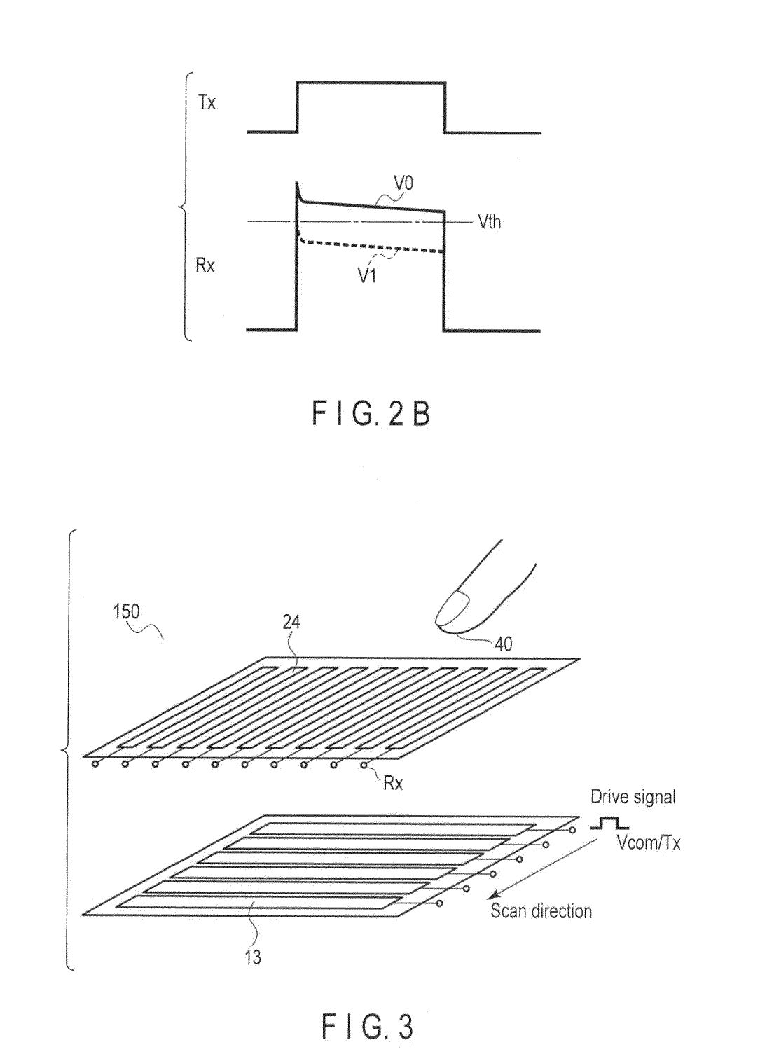

FIG. 2A shows a cross sectional view of the sensor-integrated display device 100 in which the display device component 110 and the sensor component 150, or the display panel and the operation panel are formed integrally with each other as one piece.

As shown in FIG. 2A, a pixel substrate 10 includes a thin-film transistor (TFT) substrate 11, a pixel electrode 12 and a common electrode 13. The common electrode 13 is formed on or above the thin-film transistor (TFT) substrate 11 and the pixel electrode 12 is formed above the common electrode 13 with an insulation film between them. An opposing substrate 20 is arranged opposite to and parallel with the pixel substrate 10 with a liquid crystal layer 30 between them. The opposing substrate 20 includes a color filter 22, a glass substrate 23, a sensor sensing electrode 24 and a polarizing plate 25 which are formed in order from the liquid crystal layer 30.

The common electrode 13 serves as a drive electrode for a sensor (a common drive electrode for a sensor) as well as a common drive electrode for display.

FIG. 2B shows a variation of the voltage, which is output from the intersection between the common electrode and the sensor sensing electrode via the sensor sensing electrode, from V0 to V1 when a conductor such as a user's fingertip 40 gets close to the intersection. When the user's fingertip 40 is not in contact with the intersection, current corresponding to the capacitance of the intersection (referred to as a first capacitive element hereinafter) flows according to the charge/discharge of the first capacitive element. At this time, the first capacitive element has a potential waveform of, e.g., V0 at one end, as shown in FIG. 2B. When the user's fingertip 40 gets close to the sensor sensing electrode, a second capacitive element is formed by the user's finger and connected to the first capacitive element. In this state, current flows through each of the first and second capacitive elements according to the charge/discharge of these elements. At this time, the first capacitive element has a potential waveform of, e.g., V1 at one end, as shown in FIG. 2B, and this potential waveform is detected by the sensor signal detector 250. The potential of the one end of the first capacitive element becomes a divided potential that depends upon the current flowing through the first and second capacitive elements. Thus, the value of waveform V1 is smaller than that of waveform V0. It is therefore possible to determine whether a user's fingertip 40 is in contact with a sensor by comparing the sensor signal Rx with a threshold value Vth.

FIG. 3 is a perspective view illustrating the sensor component of the operation panel and a method for driving the sensor component and showing a relationship in arrangement between the sensor sensing electrode 24 and the common electrode 13. FIG. 3 shows only one example and thus the present embodiment is not limited to it.

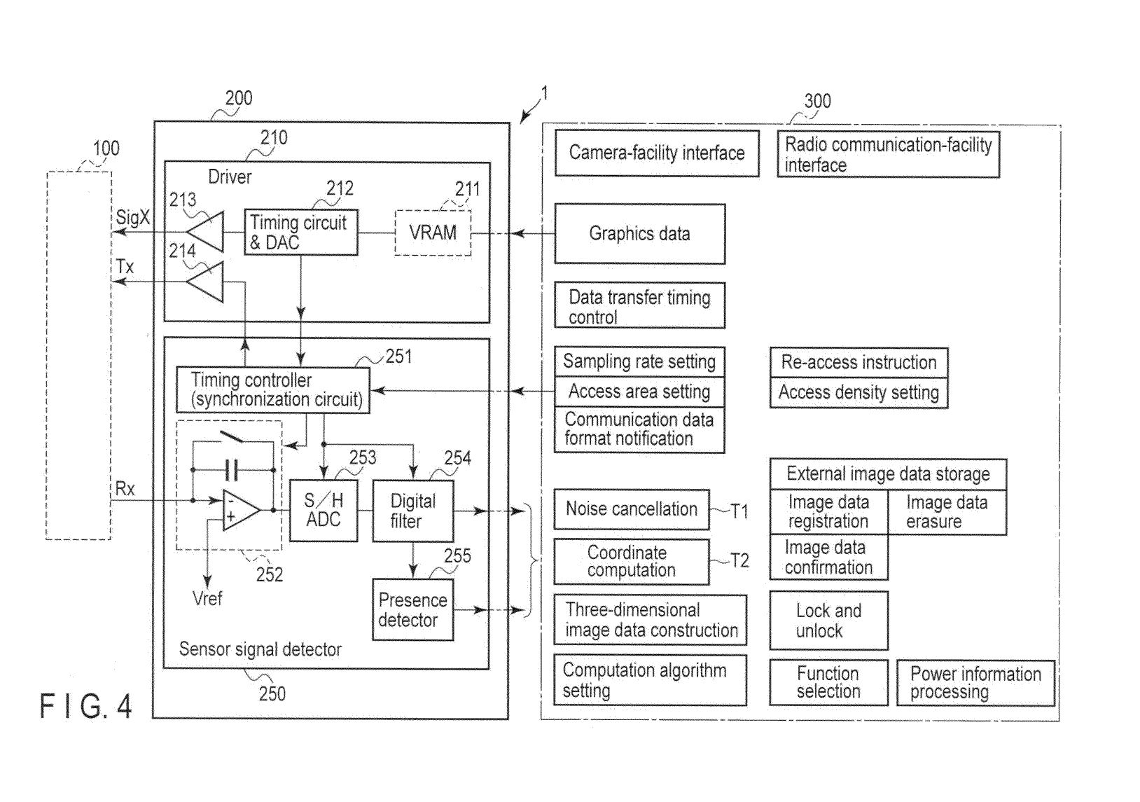

FIG. 4 shows the sensor-integrated display device 100, data transfer device 200 and application executing device 300. It also shows an example of internal components of the data transfer device 200 and the application executing device 300.

The data transfer device 200 mainly includes the driver 210 and the sensor signal detector 250. The driver 210 and the sensor signal detector 250 can be designated as a display driver IC and a touch IC, respectively. Though the driver 210 and sensor signal detector 250 are separated from each other in FIG. 4, they can be formed integrally as one chip.

The driver 210 receives display data from the application executing device 300. The display data is time-divided and has a blanking period. The display data is supplied to a timing circuit and digital-to-analog converter 212 through a video random access memory (VRAM) 211 serving as a buffer. In mobile terminal 1, the VRAM 211 may have a capacity of one frame or smaller.

Display data SigX indicative of an analog quantity output from the timing circuit and digital-to-analog converter 212 is amplified by an output amplifier 213 and supplied to the sensor-integrated display device 100 for writing it to a display element. The timing circuit and digital-to-analog converter 212 detects a blanking detection signal and supplies it to a timing controller 251 of the sensor signal detector 250. The timing controller 251 can be provided in the driver 210 and designated as a synchronization circuit.

The timing controller 251 generates a sensor access pulse to access the sensor during a given period of the display signal. The sensor access pulse is amplified by an output amplifier 214 and supplied to the sensor-integrated display device 100.

The drive signal Tx drives the sensor sensing electrode via the common electrode and thus the sensor signal Rx is output from the sensor-integrated display device 100. The sensor signal Rx is input to an integrating circuit 252 in the sensor signal detector 250. The sensor signal Rx is compared with a reference voltage (threshold value) Vref by the integrating circuit 252. If the level of the sensor signal Rx is equal to the reference voltage or higher, the integrating circuit 252 integrates the sensor signal Rx and outputs as an integral signal. The integrating circuit 252 is reset by a switch for each detection unit time period. In this way an analog signal Rx can be output from the integrating circuit 252. The output of the integrating circuit 252 is supplied to a sample hold and analog-to-digital converter 253 and converted into digital data. The digital data is supplied as raw data to the application executing device 300 through a digital filter 254.

The digital data is three-dimensional data (multivalued data) including both the detected data and non-detected data of an input operation. For example, a presence detector 255 operates when the application executing device 300 is in a sleep mode and no coordinates of a touched point on the operation surface are detected. If there is any conductor close to the operation surface, the presence detector 255 is able to sense the conductor and release the sleep mode.

The application executing device 300 receives and analyzes the digital data. In accordance with a result of the analysis, the device 300 is able to output the display data or select an operating function of the mobile terminal 1.

The application executing device 300 is able to execute each of the applications to set an operating procedure of the device, select a function, generate a display signal, select a display signal, and the like. Using a sensor signal (raw data) output from the sensor signal detector 250, the device 300 is able to analyze an operating position through a coordinate computation. The sensor signal is processed as image data and thus three-dimensional image data can be formed by an application. The device 300 is also able to, for example, register, erase and confirm the three-dimensional image data. The device 300 is also able to compare the acquired image data with the registered image data to lock or unlock an operating function.

Upon acquiring the sensor signal, the application executing device 300 is able to change the frequency of an access pulse to the sensor sensing electrode output from the timing controller 251 and control the output timing of the access pulse. Accordingly, the device 300 is able to select an access area of the sensor component 150 and set the access speed thereof.

Furthermore, the application executing device 300 is also able to set the sampling density of the sensor signal and add data to the sensor signal.

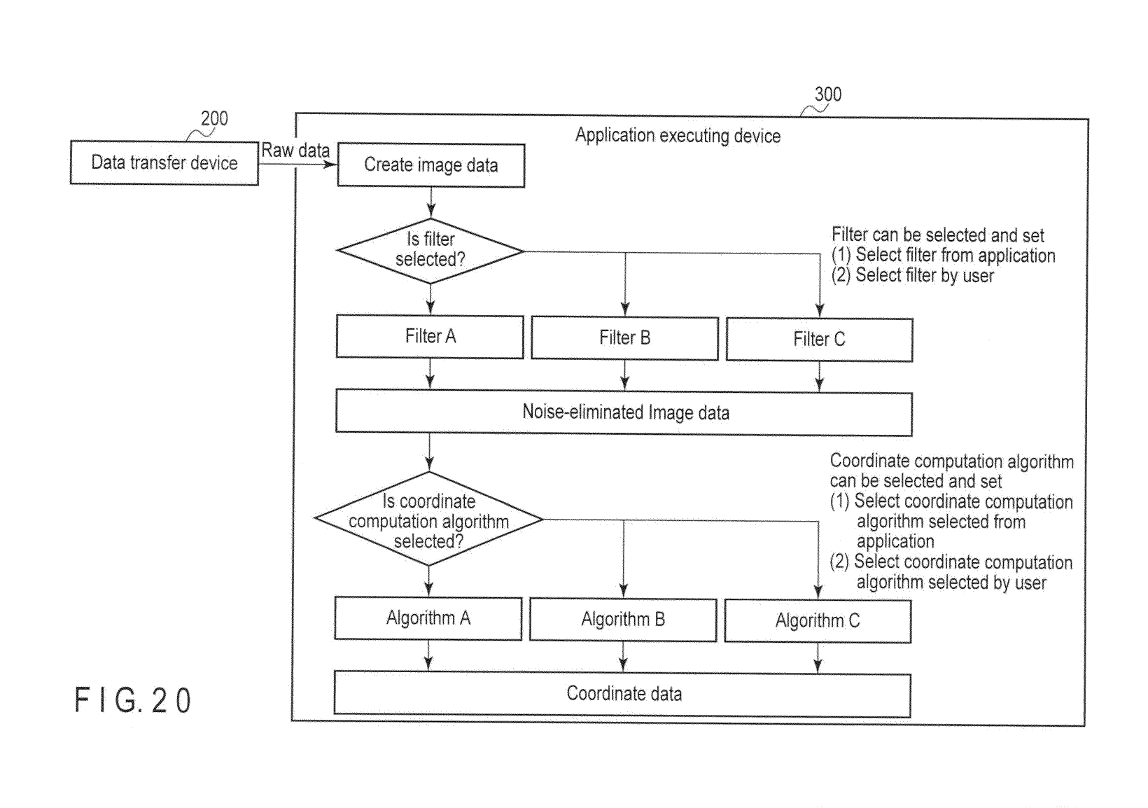

The application executing device 300 includes different filters (T1) for eliminating noise to flatten image data based on the sensor signal (raw data) and different coordinate computation algorithms (T2) for computing an operating position coordinate on the operation surface from the image data. A plurality of these filters (T1) and algorithms (T2) are prepared on the assumption that the coordinate values as computation results have deviation in accordance with the functions and conditions such as the applications and the operating positions on the sensor surface. One (one set) of the filters (T1) and coordinate computation algorithms (T2) is selected by a user or an application in accordance with usability and contents of the application. A configuration for selecting the filters (T1) and the coordinate computation algorithms (T2) are shown as Filter A, Filter B, Filter C, Algorithm A, Algorithm B and Algorithm C in FIG. 20, which will be described later.

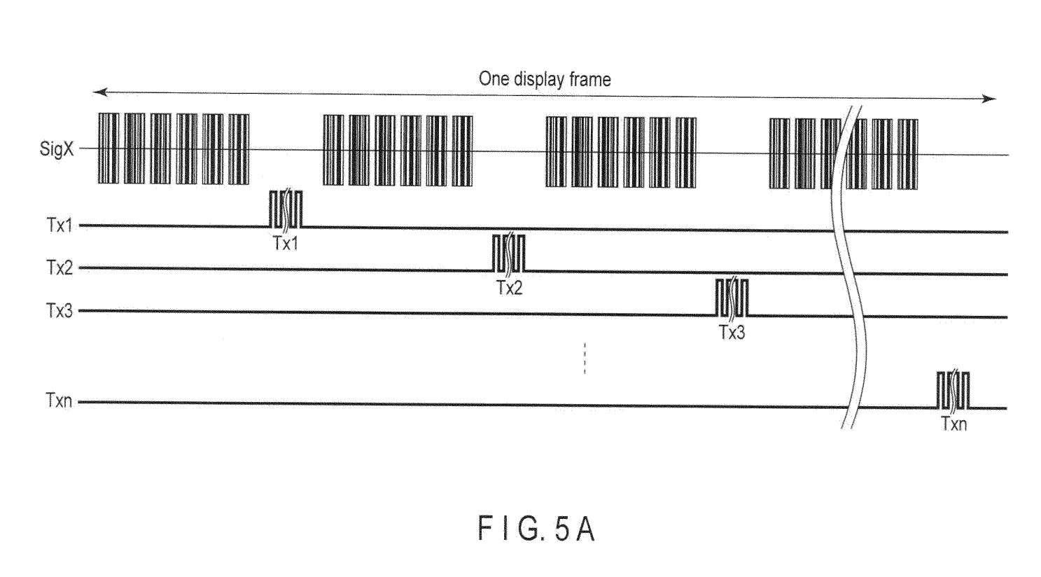

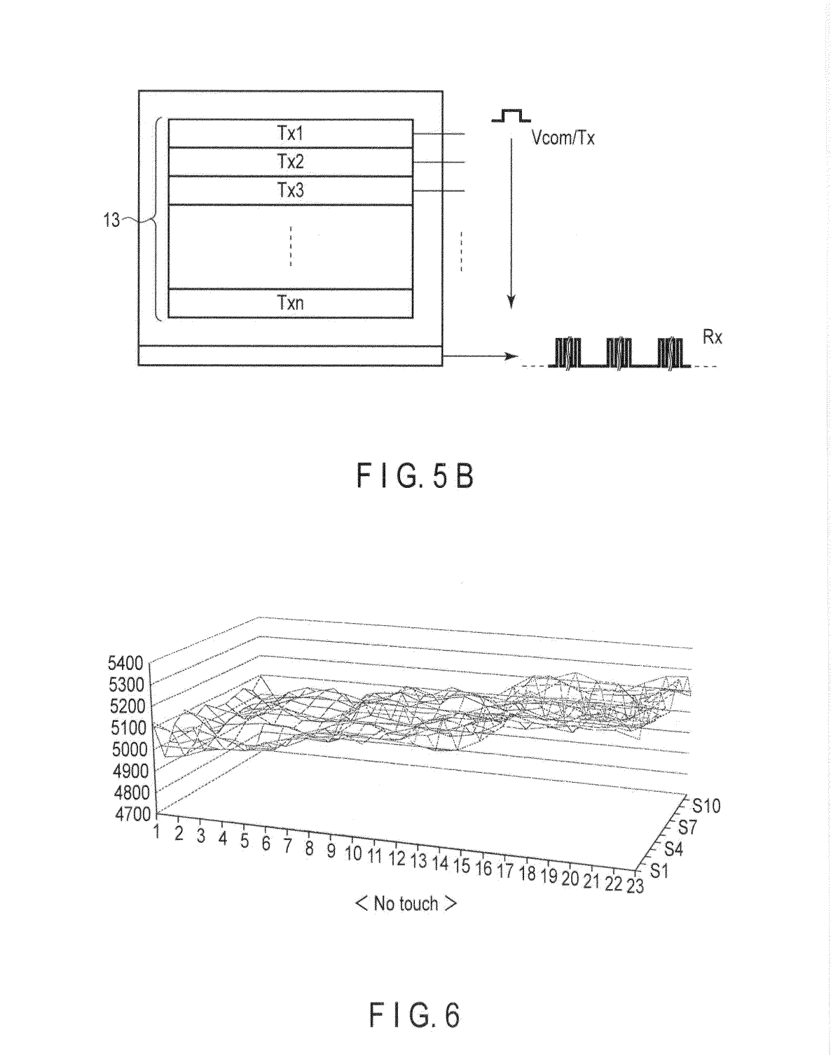

FIG. 5A shows an example of a timing chart between the time-divided display data SigX and the sensor drive signal Tx (Tx1-Txn) which are output from the data transfer device 200. FIG. 5B schematically shows that the sensor component 150 including the common electrode and the sensor sensing electrode is two-dimensionally scanned by a common voltage Vcom and the sensor drive signal Tx. The common voltage Vcom is applied to the common electrode 13, as is the drive signal Tx to generate a sensor signal during a given period of time.

The display data SigX and the sensor drive signal Tx can be separated from each other by the timing circuit and digital-to-analog converter 212. It is also possible that the display data SigX and the sensor drive signal Tx can be supplied from the application executing device 300 to the driver 210 in a time divisional manner via the same bus. The sensor drive signal Tx is supplied to the common electrode 13, described above, via the timing controller 251 and the amplifier 214. For example, the timing at which the timing controller 251 outputs the sensor drive signal Tx and the frequency of the sensor drive signal TX can be varied according to an instruction of the application executing device 300. The timing controller 251 is able to supply a reset timing signal to the integrating circuit 252 of the sensor signal detector 250 and also supply a clock to the sample hold and analog-to-digital converter 253 and the digital filter 254.

FIG. 6 is a graph showing an example of raw data output from the sensor when no input operation is detected.

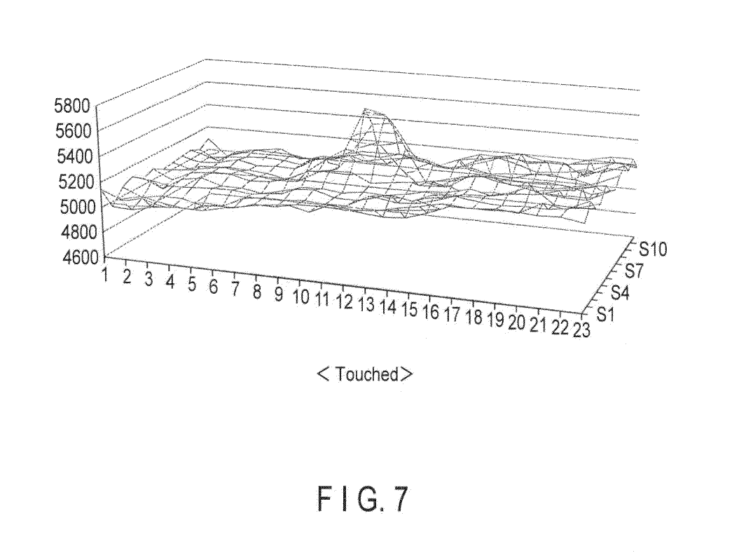

FIG. 7 is a graph showing an example of raw data output from the sensor when an input operation is detected.

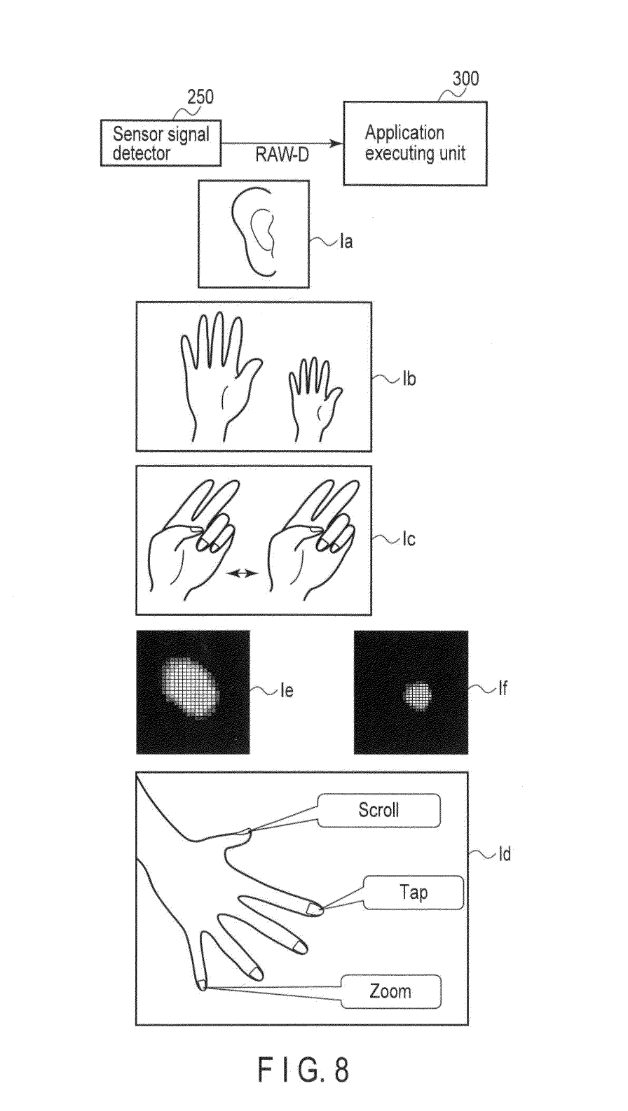

FIG. 8 shows a specific example of performing a variety of application executing functions including a multi-touch interface function by three-dimensional image data generated based on the raw data (RAW-D) input from the sensor signal detector 250 in the application executing device 300. In the example shown in FIG. 8, the three-dimensional image data generated based on the raw data (RAW-D) makes it possible to recognize a variety of states and operations on the sensor surface, such as a shape of an operator's (user's) ear (Ia), shapes of palms (Ib) of an adult when an operator is the adult, shapes of palms (Ib) of a child when an operator is the child, a combination of a specific gesture and an operation (Ic), a touch operation of a plurality of fingers (Id), a state in which an operator touches the sensor surface with his or her finger's back (Ie) and a state in which an operator touches the sensor surface with his or her fingertip (If). If the three-dimensional image data capable of recognizing these states and operations is registered together with the application executing functions, a variety of control operations can be carried out by image check.

When an operator places his or her ear on the sensor surface of the mobile terminal 1, the application executing device 300 is able to recognize a shape of the ear (Ia) to judge whether the operator is correct and control another function. In the judgment, if the operator is identified by the shape of the ear, the function of the mobile terminal 1 can be unlocked. In the function control, if the operator places his or her ear on the sensor surface, it is recognized that the operator starts a call to make it possible to change a function automatically, namely, change an operation mode to a call mode (reception state).

When the size of an operator's palm is recognized (Ib), it is possible to provide applications for each generation, provide applications for each user, allow an operator to use an apparatus or an application or inhibit the operator from using it, and the like.

When a specific gesture and an operation are combined (Ic), if an operator touches the operation surface continuously two times with his or her index and middle fingers shaping a peace-sign, a camera application is started to allow a picture to be taken, and if the operator touches the operation surface continuously three times with the peace-sign fingers, a music player application is started to allow music to be played back.

When an operator uses his or her fingers properly (Id) to scroll with his or her thumb, tap with his or her index finger and zoom with his or her little finger, an operating function need not be changed.

When an operator's touch with a finger's back (Ie) and an operator's touches with a fingertip (If) are distinguished from each other, their respective applications can be started.

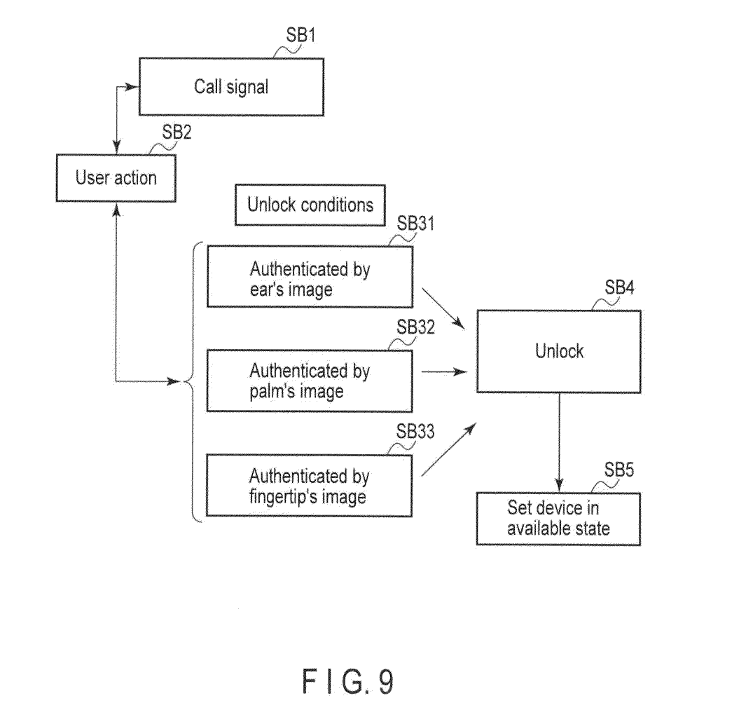

FIG. 9 shows an example of unlocking a function of the mobile terminal 1 by recognizing the above-described operations. The example of FIG. 9 is directed to a case where authentication is performed by the shape of an ear (SB31), a case where authentication is performed by the shape of a palm (SB32) and a case where authentication is performed by the shape of a fingertip (SB33). The function of the mobile terminal 1 is selectively unlocked (SB4) under OR conditions or AND conditions of the cases (SB31) to (SB33) to make the mobile terminal 1 available (SB5). This unlock configuration is able to improve the ease-of-use of an authentication function that conforms to a security level.

The three-dimensional image data for use in the above authentications can smoothly be registered by, for example, either or both of an image registration screen and audio guidance.

The application executing device 300 includes in advance an operating procedure of performing an image registration process and an authentication process to fulfill an application function corresponding to the operations based on the three-dimensional image data.

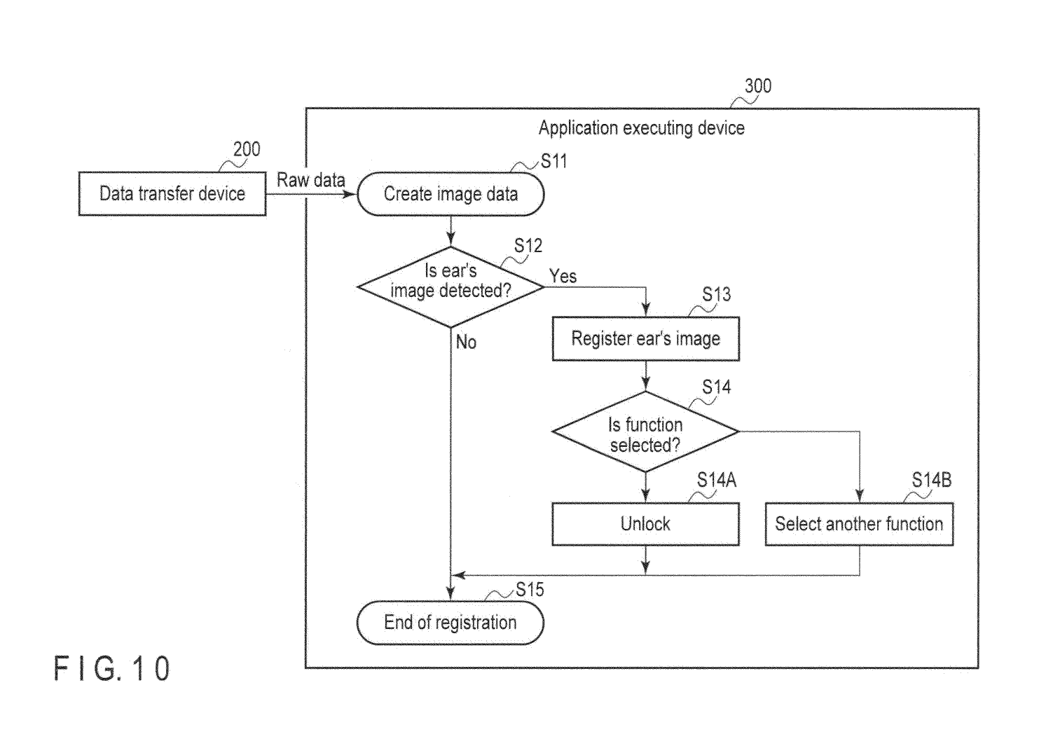

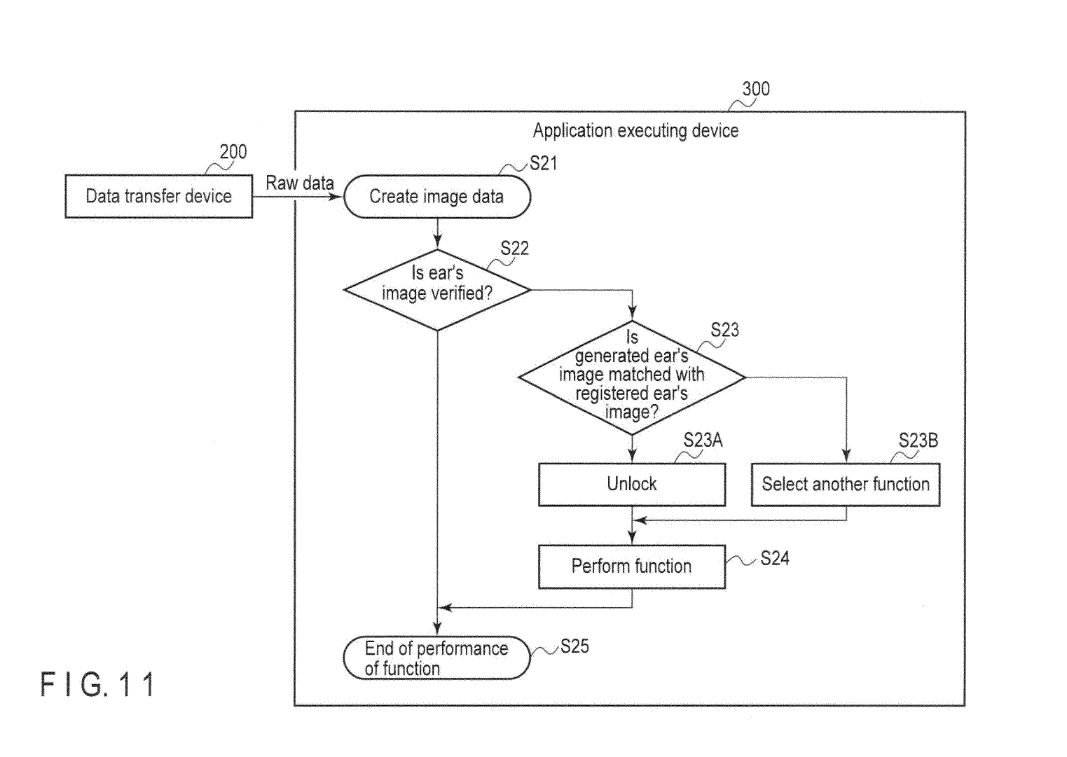

FIGS. 10 and 11 show an authentication process of registering and selectively unlocking a function of the mobile terminal 1 by recognizing a shape of a user's ear (Ia).

FIG. 10 shows an example of a registration sequence. In this registration sequence, the three-dimensional image data of an ear of a user with a mobile terminal 1 is registered in an application running on the application executing device 300 (S11 to S13), a function is selected according to the registered three-dimensional image data (S14), register the unlock (S14A) function, thus completing the registration process of authentication by the shape of the ear. Instead of the unlock function, another function can be used (S14B).

FIG. 11 shows an example of an unlock sequence. In the unlock sequence, when a user with the mobile terminal 1 places his or her ear on the sensor surface of the sensor component 150, three-dimensional image data of the ear is generated and verified in the application in which three-dimensional image data of the ear is pre-registered (S21 and S22). Then, it is determined whether the generated three-dimensional image data and the registered three-dimensional image data are matched with each other (S23). When it is determined that they are matched with each other, the application is unlocked (S23A to S24). Instead of the unlock function, another function can be used (S23B).

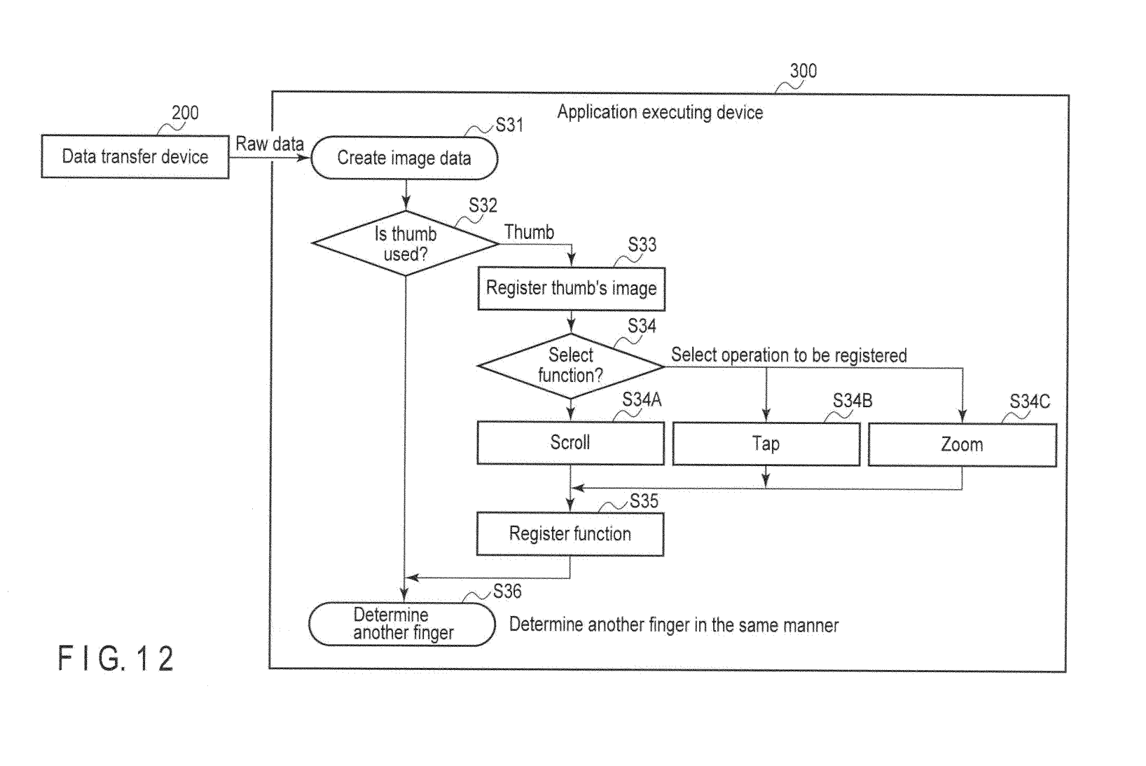

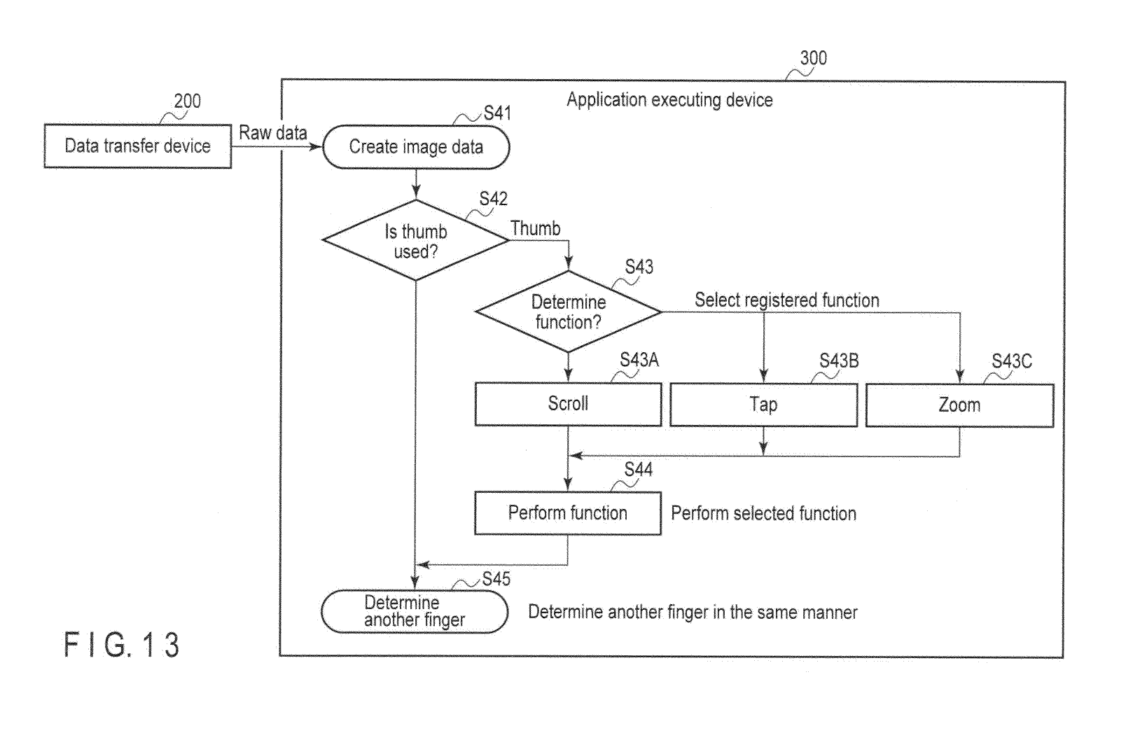

FIGS. 12 and 13 show a registration and operation capable of performing an input operation using a plurality of fingers properly (Id).

FIG. 12 shows an example of a registration sequence. In the registration sequence, the shape of each finger used for an operation on the sensor surface is pre-registered as three-dimensional image data. For example, if a user scrolls with his or her thumb, taps with his or her index finger and zooms with his or her little finger, first of all the user registers three-dimensional image data of the thumb by touching the sensor surface with his or her thumb (S31 to S33). Then, the user selects a function (S34) and registers an operating function (scroll function) of the registered thumb (S34A to S35). Subsequently, the user registers three-dimensional image data of the index finger and an operating function (tap function) of the index finger (S34B to S35) and then registers three-dimensional image data of the little finger and an operating function (zoom function) of the little finger (S34C to S35) in the same way.

FIG. 13 shows an example of an operation sequence. In the operation sequence, the image data of a user's finger touched on the sensor surface and that of the registered fingers are cross-checked against each other (S43), and each of the scroll operation with a thumb (S43A to S44), the tap operation with an index finger (S43B to S44) and a zoom operation with a little finger (S43C to S44) can be performed without selecting a function.

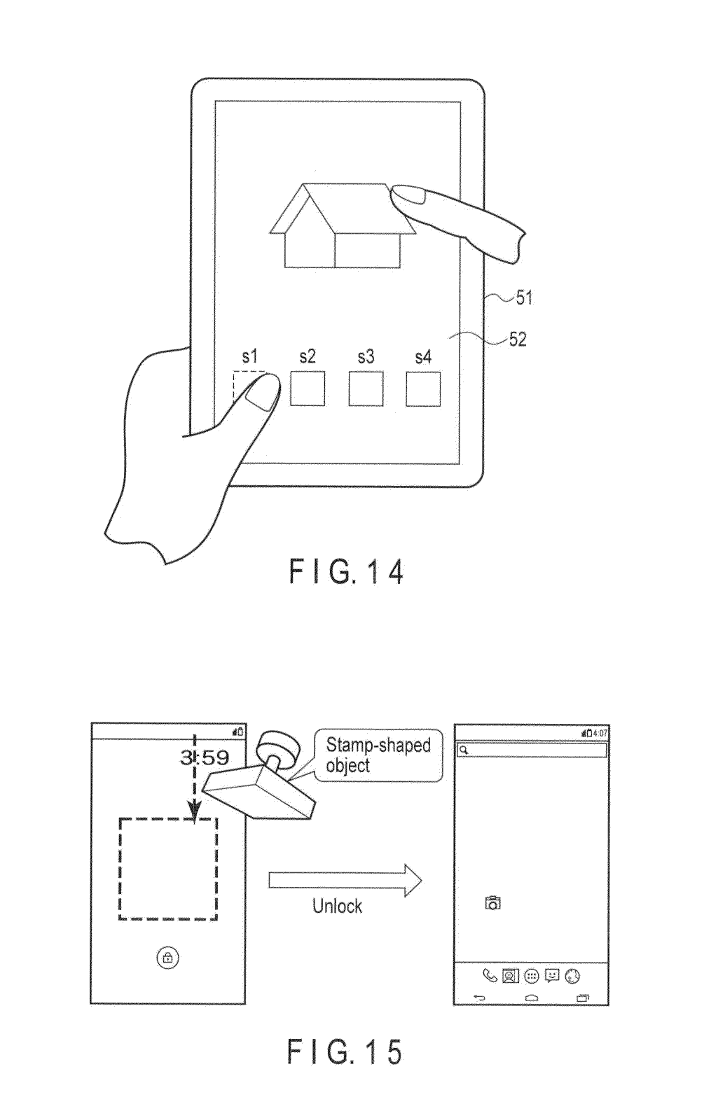

FIG. 14 shows an example of an operation for selecting an application function by touching two different points on the sensor surface. If a user selects a drawing line type with his or her left thumb and touches a drawing portion with his or her right index finger, the line type of the drawing portion can be changed. If the user designates and selects a drawing color with his or her left thumb and touches a drawing portion with his or her right index finger, the color of the drawing portion can be changed. If the user selects cancellation of a drawing portion with his or her left thumb and touches the drawing portion with his or her right index finger, the drawing portion can be erased by an erasing rubber. Thus, a function can be selected according to an operation using a plurality of fingers to fulfill a touch function that is improved in operability.

FIG. 15 shows an example of pre-registering image data in a specific shape and using it as a pattern for authentication at the time of an unlock operation. If image data in a specific shape, such as stamp image data is pre-registered, an authentication process for the unlock operation can be performed using the stamp image data.

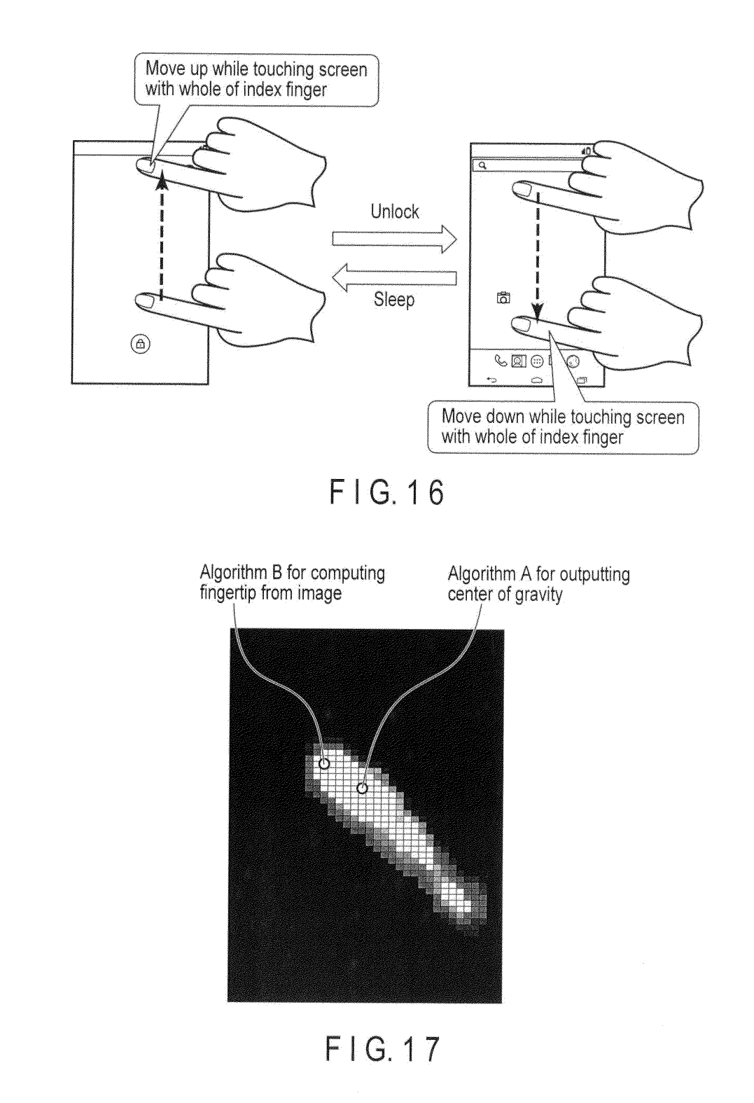

FIG. 16 shows an example of pre-registering image data for several frames and using it as a gesture. If a user's index finger is slid in the upper direction with its entire back on the sensor surface, an unlock operation is performed and the index finger is slid in the opposite direction, with the result that a function of making the mobile terminal in a sleep state can be controlled.

As an application of the function shown in FIG. 16, one of different operations of selecting the previous music or the next music, starting and stopping a music player, and the like can be selected in accordance with the finger operating direction. A user need not always perform these operations while he or she touches the sensor surface with his or her finger as a conductor but can perform them (from outside a bag, for example) without touching the sensor surface by adjusting a sensing level of the sensor surface such that the operations can be sensed by three-dimensional image data based on raw data (RAW-D).

In order to achieve the above different application functions, a high-precision position coordinate computation function is required in accordance with the characteristics of the application functions. In recent years, the sensor-integrated display device has been increased in precision to require a very fine operation.

Under the above situation, as a touch user interface in the sensor-integrated display device, there occurs a sense of operation (a difference between a point that a user wishes to touch and a touch coordinate recognized by the device) which varies from user to user.

To solve the above problem, in the present embodiment, the application executing device 300 performs a high-speed computation function to compute a correct coordinate that is adapted to a user's operation using three-dimensional image data based on raw data (RAW-D).

In the present embodiment, a plurality of filters (T1) and a plurality of coordinate computation algorithms (T2), which correspond to those as shown in FIG. 4, are prepared and used properly according to their use and purposes, physical conditions and the like or they can be selected arbitrarily according to a user's habit, a user's liking or the like. These filters (T1) and coordinate computation algorithms (T2) differ in, for example, a structural element including a computation parameter in the computing process.

To use the filters (T1) and coordinate computation algorithms (T2) properly according to an application, a correspondence table in which the applications in the application executing device 300 correspond to the filters (T1) and coordinate computation algorithms (T2), is prepared. Referring to the correspondence table in accordance with a starting application, a user selects a filter (T1) and a coordinate computation algorithm (T2) and performs a computation for an operating position coordinate using the selected filter (T1) and coordinate computation algorithm (T2). When a user arbitrarily selects a filter (T1) and a coordinate computation algorithm (T2), a coordinate recognition process that is the most suitable for a user's habit, a user's liking or a specific application operation, is carried out.

FIG. 17 shows a plurality of examples of the coordinate computation algorithms. For example, a coordinate computation algorithm (algorithm A) for computing, from the three-dimensional image data, the center of gravity of a finger with which a touch operation is performed or a coordinate computation algorithm (algorithm B) for computing, from the three-dimensional image data, a fingertip with which a touch operation (or a non-touch operation) is performed, can be selected according to a user or an application.

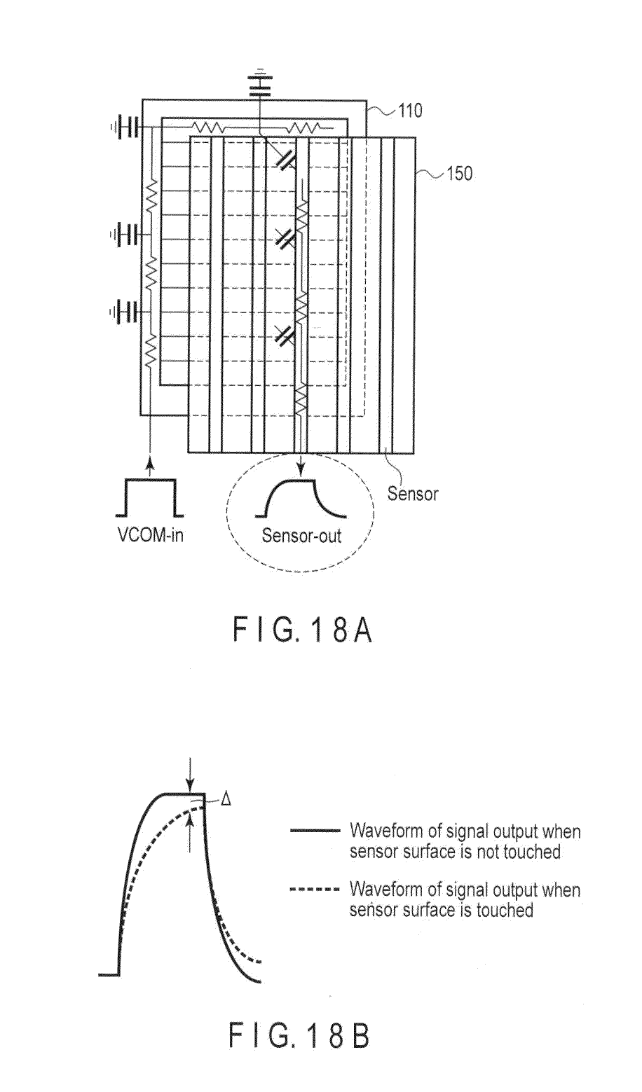

FIG. 18A shows an equivalent circuit of a sensor for acquiring touch data and FIG. 18B shows waveforms of sensor signals output from the sensor. If a difference Δ (a portion interposed between two arrows in FIG. 18B) between sensor signal outputs from a sensor line when a user touches the sensor surface and a sensor signal output from the sensor line when the user does not touch the sensor surface is defined as a signal, the difference Δ is output similarly from all the sensor lines. Image data is formed by the difference Δ in all sensor signals. Of the sensor signals, a sensor signal having a value exceeding a threshold value is computed as touch data. The difference Δ is caused by blocking an electric field generated from both sides of each of the sensor lines. The larger a target conductor is, the greater the difference Δ can be obtained.

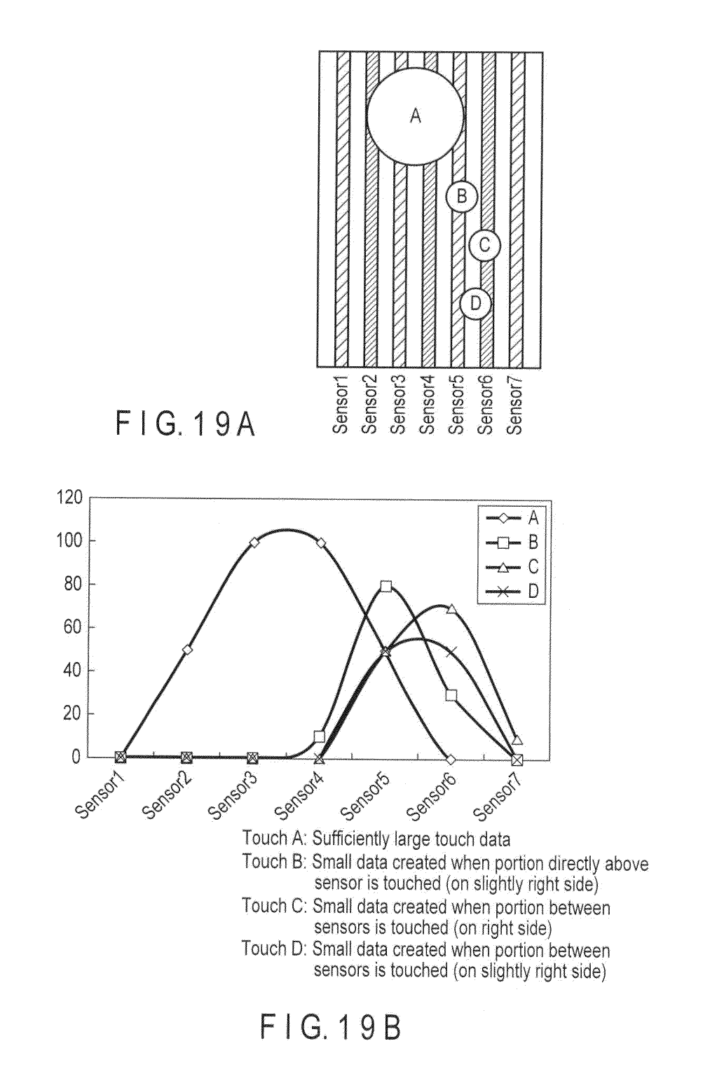

FIG. 19A shows images of different sizes touched on the sensor lines and FIG. 19B shows touch data of each of the touched images. When a touched image having a value exceeding a threshold value is small, electric fields across both sides of a sensor line cannot sufficiently be blocked. The difference greatly varies between when a user touches a portion directly above a sensor line and when the user touches a portion between two sensor lines; accordingly, the difference Δ needs to be corrected to be uniformity.

FIG. 20 shows a touch coordinate computation configuration which includes a plurality of filters and a plurality of coordinate computation algorithms and which can be used properly or selected according to the above different conditions such as uses and purposes. The touch coordinate computation configuration is realized by the touch coordinate computation unit (P3) shown in FIG. 1.

The filters and coordinate computation algorithms include operating conditions or computing elements, in which the values of the result of computation of each coordinates do not necessarily coincide.

In calculating a touch coordinate from the three-dimensional image data based on the raw data (RAW-D), one coordinate computation algorithm, which is adapted to a user or an application, is selected, by the user or the application, from a plurality of filters (Filter A, Filter B and Filter C) and a plurality of coordinate computation algorithms (Algorithm A, Algorithm B and Algorithm C) which are prepared.

In the process of obtaining a coordinate from the three-dimensional image data based on the raw data (RAW-D), image data from which noise is eliminated using a selected filter (e.g., Filter A) is acquired, and a touch operation coordinate is computed using a selected coordinate computation algorithm (e.g., Algorithm B). In a high-precision panel that requires a touch operation with a very fine pitch, therefore, a coordinate can be designated correctly in accordance with a user or an application for a variety of application operations, thereby providing a coordinate input function that is decreased in operation error and improved in usability.

Instead of the above coordinate computation configurations, for example, a coordinate value complementary table can be prepared to register therein a correction factor of each coordinate value for each of the applications (coordinate computation algorithms) for processing coordinate data so as to correspond to the application and correct the coordinate value using the correction factor registered in the coordinate value complementary table.

The above embodiments of the present disclosure are each described as an example and do not aim at limiting the scope of the present disclosure. The embodiments can be reduced to practice in different ways, and their structural elements can be omitted, replaced and modified in different ways without departing from the spirit of the invention. Even though the structural elements are each expressed in a divided manner or they are expressed in a combined manner, they fall within the scope of the present invention. Even though the claims are recited as method claims, step claims or program claims, these claims are applied to the device according to the invention. The embodiments and their modifications fall within the scope and spirit of the invention and also fall within the scope of the invention recited in the claims and its equivalents.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An electronic device comprising:
a sensor-integrated display device including a display surface from which display information is output and a sensor surface to which operation information is input, the display surface and the sensor surface being formed integrally with the sensor-integrated display device as one piece;
a data transfer unit which generates and outputs three-dimensional information in response to a signal sensed on the sensor surface;
an image generation unit which generates three-dimensional image data in a plurality of points sensed on the sensor surface, based on the three-dimensional information output from the data transfer unit; and
a coordinate computation unit which computes a coordinate value of a conductor operated on the sensor surface, based on the image data generated by the image generation unit.

2. The electronic device of claim 1, wherein the three-dimensional information is operation information indicating proximity of the conductor in a point sensed on the sensor surface.

3. The electronic device of claim 1, wherein the data transfer unit transfers the three-dimensional information to the image generation unit in synchronization with display drive timing at which display information is displayed on the display surface.

4. The electronic device of claim 1, wherein the image generation unit and the coordinate computation unit allow different applications to be executed and are provided in an application executing device that is configured by a single semiconductor integrated circuit including a base band engine.

5. The electronic device of claim 1, wherein the image generation unit generates the image data, based on the three-dimensional information of all points sensed on the sensor surface, in synchronization with display drive timing at which display information is displayed on the display surface.

6. The electronic device of claim 1, wherein the coordinate computation unit includes different filters to eliminate noise from the image data, and one of the filters is allowed to be selected by one of a user operation and an application.

7. The electronic device of claim 1, wherein the coordinate computation unit includes different coordinate computation algorithms to obtain an operating position coordinate from the image data, and a set of coordinate computation algorithms is allowed to be selected by one of a user operation and an application.

8. A method for controlling an electronic device including a sensor-integrated display device including a display surface from which display information is output and a sensor surface to which operation information is input, the display surface and the sensor surface being formed integrally with the sensor-integrated display device as one piece, the method comprising:
acquiring three-dimensional information generated in response to a signal sensed on the sensor surface;
generating three-dimensional image data in a plurality of points sensed on the sensor surface, based on the acquired three-dimensional information; and
computing a coordinate value of a conductor operated on the sensor surface, based on the generated image data.

9. The method of claim 8, wherein the coordinate value is computed using one of different filters to eliminate noise from the image data, the one of the different filters being selected by one of a user operation and an application.

10. The method of claim 8, wherein the coordinate value is computed using a set of different coordinate computation algorithms to obtain an operating position coordinate from the image data, the set of different coordinate computation algorithms being selected by one of a user operation and an application.

11. A method for controlling an electronic device including a sensor-integrated display device including a display surface from which display information is output and a sensor surface to which operation information is input, the display surface and the sensor surface being formed integrally with the sensor-integrated display device as one piece, the method causing a computer to:
acquire three-dimensional information generated in response to a signal sensed on the sensor surface;
generate three-dimensional image data in a plurality of points sensed on the sensor surface, based on the acquired three-dimensional information; and
compute a coordinate value of a conductor operated on the sensor surface, based on the generated image data.

12. The method of claim 11, which causes the computer to compute the coordinate value using one of different filters to eliminate noise from the image data, the one of the different filters being selected by one of a user operation and an application.

13. The method of claim 11, which causes the computer to compute the coordinate value using a set of different coordinate computation algorithms to obtain an operating position coordinate from the image data, the set of different coordinate computation algorithms being selected by one of a user operation and an application.

14. The method of claim 12, which causes the computer to compute the coordinate value using a set of different coordinate computation algorithms to obtain an operating position coordinate from the image data, the set of different coordinate computation algorithms being selected by one of a user operation and an application.

15. The electronic device of claim 6, wherein the coordinate computation unit includes different coordinate computation algorithms to obtain an operating position coordinate from the image data, and a set of coordinate computation algorithms is allowed to be selected by one of a user operation and an application.

16. The method of claim 9, wherein the coordinate value is computed using a set of different coordinate computation algorithms to obtain an operating position coordinate from the image data, the set of different coordinate computation algorithms being selected by one of a user operation and an application.
